(19) United States
(12) Patent Application Publication
(10) Pub. No.: US 2016/0326785 A1
(43) Pub. Date: Nov. 10, 2016

(54) LOCKING ATTACHMENT DEVICE

(71) Applicants: Tarsha Tremease HILL, Phenix City, AL (US); Anthony WILBORN, Phenix City, AL (US)

(72) Inventors: Tarsha Tremease HILL, Phenix City, AL (US); Anthony WILBORN, Phenix City, AL (US)

(21) Appl. No.: 15/148,784

(22) Filed: May 6, 2016

Related U.S. Application Data
(60) Provisional application No. 62/157,804, filed on May 6, 2015.

(51) Int. Cl. E05C 19/18; E05C 19/10; E05C 19/00

(52) U.S. Cl. CPC E05C 19/188; E05C 19/003; E05C 19/10

(57) ABSTRACT

A locking attachment device is provided. The locking attachment device has opposing C-shaped links, each link having a sleeve slidable between an open configuration and a closed configuration, wherein each sleeve can close off the opening of the associated C-shaped link in a locking engagement, and wherein the opposing C-shaped links are rotatable relative to each other.

### CROSS-REFERENCE TO RELATED APPLICATION

This application claims the benefit of priority of U.S. provisional application No. 62/157,804, filed 6 May 2015, the contents of which are herein incorporated by reference.

### BACKGROUND OF THE INVENTION

The present invention relates to locking attachment devices and, more particularly, to a locking attachment device having opposing C-shaped links, each link having a sleeve slidable between an open configuration and a closed configuration, wherein each sleeve can close off the opening of the associated C-shaped link in a locking engagement, and wherein the opposing C-shaped links are rotatable relative to each other.

There are devices called the C-clamp and they are made like the shape of a C, however they are unsafe because they screw into a holding position but has no lock or support to hold it in position. As a result, such devices don't work well because any type of constant movement will cause the screw on the clamp to back open and whatever is inside the clamp will be disconnected and at risk, and it could be a risk to others and anything around it.

As can be seen, there is a need for a locking attachment device having opposing C-shaped links, each link having a sleeve slidable between an open configuration and a closed configuration, wherein the sleeve closes off the opening of the C-shape, and wherein the opposing C-shaped links are rotatable relative to each other.

### SUMMARY OF THE INVENTION

In one aspect of the present invention, a swivel lock connector includes two links of bar material, wherein each link extends from a first portion to a second portion so as to define an open loop with a void between the first portion and the second portion, each link further including a through bore provided in each link; a link button hole provided by the second portion; and a locking button biased to protrude from the link button hole; one gate sleeve associated with each link, each gate sleeve slidable along the associated first and second portions, wherein each gate sleeve is moveable between an open configuration and a closed configuration ensleeving the associated void, and wherein each gate sleeve provides a gate button hole dimensioned to slidable receive the associated locking button; and a pin disposed within the through bore of each link for making the two links rotatable relative to each other in opposing direction.

In another aspect of the present invention, the swivel lock connector includes two links of bar material, wherein each link extends from a first portion to a second portion so as to define an open loop with a void between the first portion and the second portion, each link further including a through bore provided in each link; link threading provided along the second portion; a link button hole provided along the link threading; a locking button slidably received in the link button hole; and a coil spring disposed in the link button to resiliently urge the locking button to protrude from the link button hole; one gate sleeve associated with each link, each gate sleeve slidable along the associated first and second portions, wherein each gate sleeve is moveable between an open configuration and a closed configuration ensleeving the associated void, wherein each gate sleeve provides a gate button hole dimensioned to slidable receive the associated locking button, and wherein gate threading is provided along an inner periphery of each gate sleeve, wherein the gate threading is adapted to engage the associated link threading; and a pin disposed within the through bore of each link for making the two links rotatable relative to each other in opposing direction.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention in a closed configuration and in a locking engagement;

FIG. 2 is a perspective view of an exemplary embodiment of the present invention, illustrating an open configuration;

FIG. 3 is a section view of an exemplary embodiment of the present invention, taken along line 3-3 of FIG. 1;

FIG. 4 is a detail section view of an exemplary embodiment of the present invention;

FIG. 5 is a section view of an exemplary embodiment of the present invention, taken along line 3-3 of FIG. 4, illustrating a protruding condition of a locking button;

FIG. 6 is a section view of an exemplary embodiment of the present invention, illustrating moving the locking button to a circumscribed condition; and

FIG. 7 is a top view of an exemplary embodiment of the present invention, illustrating the ability of each link of the present invention to swivel at least 360 degrees relative to the other link.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a locking attachment device having opposing C-shaped links, each link having a sleeve slidable between an open configuration and a closed configuration, wherein each sleeve can close off the opening of the associated C-shaped link in a locking engagement, and wherein the opposing C-shaped links are rotatable relative to each other.

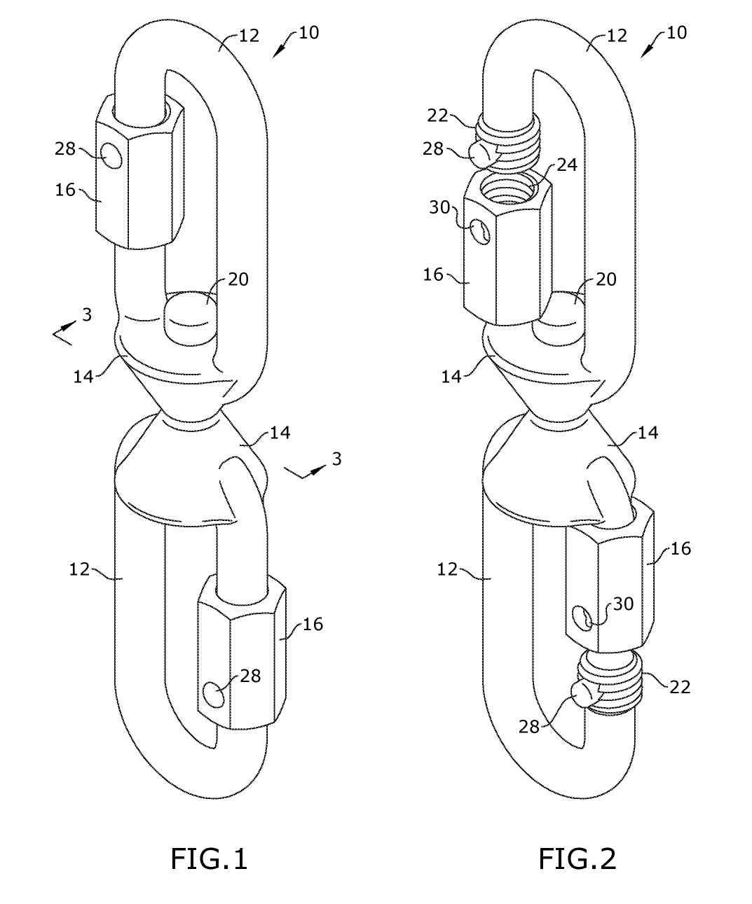

Referring to FIGS. 1 through 7, the present invention may include a swivel lock connector 10. The swivel lock connector 10 may include two links 12 joined together at proximal ends thereof. Each link 12 has a shape of a loop of bar material, having a proximal end 14 and an opposing distal end. Generally, the shape of the loop may be oval, as shown, but the shape may be circular, rectangular, square or the like as long as links 12 functions in accordance with the present invention as described herein. Similarly, a periphery of the bar material may be cylindrical, rectangular or the like. The bar material may be made out of metal or any other suitably strong material. Each link 12 loop may be any suitable size.

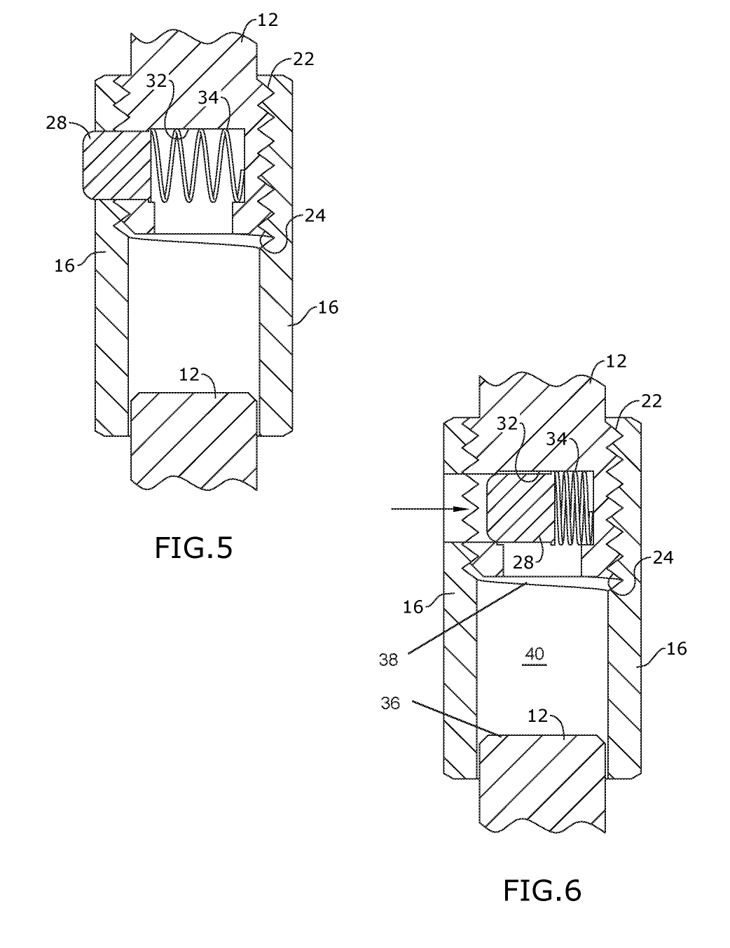

Each link 12 is an open loop provided by a void 40 disposed between the distal end and the proximal end 14, wherein the void 40 is defined by a first portion 36 and a second portion 38 of the link 12, as illustrated in FIG. 6. The second portion 38 may provide link threading 22 along a periphery thereof. A link button hole 32 may be provided along the link threading 22. A locking button 28 may be disposed within the link button hole 32. Also disposed within the link button hole 32 may be a coil spring 34, one end seated in the link button hole 32 and the other end operatively engaging the locking button 28 resiliently urging the locking button 28 to protrude from the link button hole 32, as illustrated in FIG. 5. Yet the locking button 28 is yieldably so as to be movable with an axial force from such a protruding condition to a circumscribed condition, completely circumscribed by the link button hole 32, as illustrated in FIG. 6.

The swivel lock connector 10 may provide a gate sleeve 16 for each link 12, wherein each gate sleeve 16 has an inner diameter/periphery dimensioned to slide along the first portion 36 and/or the second portion 38, between an open configuration and a closed configuration ensleeving the entire void 40. Ensleeving fully obstructs the void 40, as illustrated in FIGS. 1 and 3 through 6. The gate sleeve 16 may provide sleeve threading 24 along at least a portion of the inner diameter/periphery for securely engaging the link threading 22 in or near the closed configuration. The gate sleeve 16 may provide a gate button hole 30 along the sleeve threading 24, wherein the gate button hole 30 is dimensioned so that when it aligns with the link button hole 32 the biased locking button 28 is urged through and disposed within both the gate and link button holes 32, 30, establishing a locking engagement.

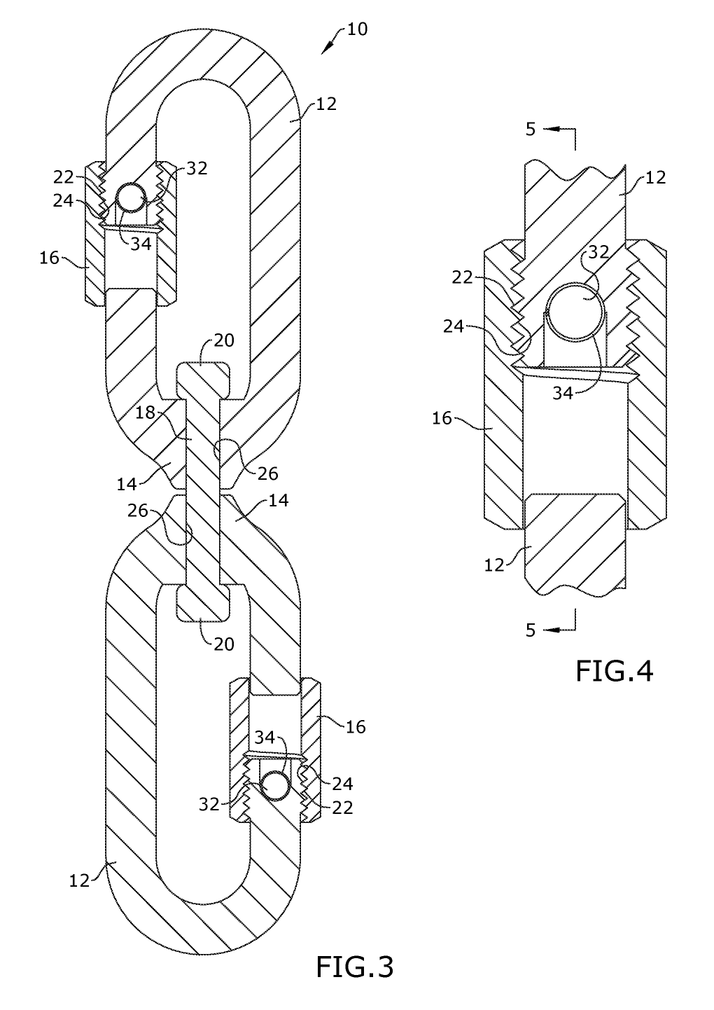

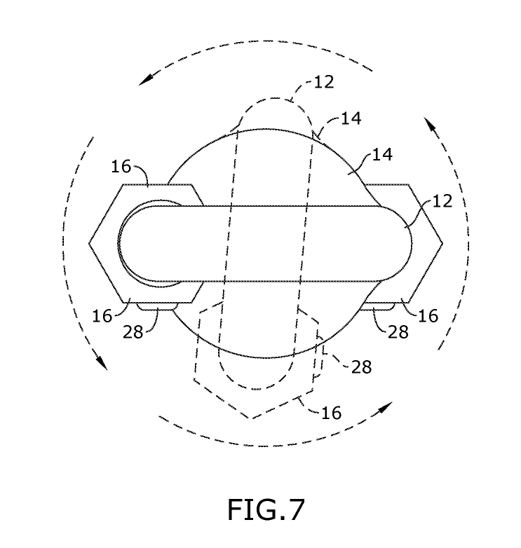

The proximal end 14 of each link 12 may provide a wider periphery that the remaining part of the link 12. For example, the proximal end 14 may have a pedestal shape, as shown in the Figures. Each proximal end 14 includes a through bore 26. The swivel lock connector 10 includes a pin 18 disposed in the two aligned through bores 26 of the two links 12, as illustrated in FIG. 3. The pin 18 has opposing wider pin heads 20 dimensioned to prevent the pin 18 from sliding through the two aligned through bores 26. The pin 18 disposed in both aligned through bores 26 enables each link 12 to rotate about the pin 18 relative to the opposing link 12 at least 360 degrees in either rotational direction, as illustrated in FIG. 7.

A method of using the present invention may include the following. The swivel lock connector 10 above may be provided. A user wanting to securely connected a first loop of a first object to a second loops of a second object receives, in the open configurations, a portion of the first loop through the void 40 of the first link 12 so that the user may slide the gate sleeve 16 into the closed configuration until locking engagement is established by the locking button 28 protruding through the gate button hole 30. In the closed configuration the first loop cannot disengage from the now-closed loop of the first link 12. The user may have to first depress the locking hole 28 into the circumscribed condition to enable the closed condition and the locking engagement. The user may then swivel the second link 12 about the pin 18 anywhere from zero to 360 plus degrees in order to engage the second loop in a similar fashion as described immediately above. Subsequent use, the user may move both links from the locking engagement by depressing the associated locking button 28, moving the links to the open configuration, and set the first and second loops free.

The present invention may be used for a variety of mechanical purposes, such as a shackle, or hooking device that easily connects to cables on an engine puller and it gives the right amount of turning degree so that you can maneuver the engine in the direction that you desire because of the 360 degree turn ability of the device. A person can use the present invention on sailboats where swiveling would be necessary and a locking engagement mechanism that gives you quick opening of the swivel without tools and provides safety convenience while sailing. The present invention also can be used for dog chain hook-ups, as well as solve the problem of dog chain tangling because of its swivel body, which turns 360 degrees so the chain will always stay in an untangled form.

It should be understood, of course, that the foregoing relates to exemplary embodiments of the invention and that modifications may be made without departing from the spirit and scope of the invention as set forth in the following claims.

What is claimed is:

1. A device, comprising:
two links of bar material, wherein each link extends from a first portion to a second portion so as to define an open loop with a void between the first portion and the second portion, each link further comprising:
a through bore provided in each link;
a link button hole provided by the second portion; and
a locking button biased to protrude from the link button hole;
one gate sleeve associated with each link, each gate sleeve slidable along the associated first and second portions, wherein each gate sleeve is moveable between an open configuration and a closed configuration ensleeving the associated void, and wherein each gate sleeve provides a gate button hole dimensioned to slidable receive the associated locking button; and
a pin disposed within the through bore of each link for making the two links rotatable relative to each other in opposing direction.

2. The device of claim 1, further comprising a coil spring disposed in the link button to bias the locking button.

3. The device of claim 1, further comprising link threading provided along the second portion.

4. The device of claim 1, further comprising gate threading along an inner periphery of each gate sleeve, wherein the gate threading is adapted to engage the associated link threading.

5. The device of claim 1, further comprising a pin head on each of the opposing ends of the pin.

6. The device of claim 1, wherein each open loop link defines an oval shape.

7. A device, comprising:
two links of bar material, wherein each link extends from a first portion to a second portion so as to define an open loop with a void between the first portion and the second portion, each link further comprising:
a through bore provided in each link;
link threading provided along the second portion;
a link button hole provided along the link threading;
a locking button slidably received in the link button hole; and
a coil spring disposed in the link button to resiliently urge the locking button to protrude from the link button hole;
one gate sleeve associated with each link, each gate sleeve slidable along the associated first and second portions, wherein each gate sleeve is moveable between an open configuration and a closed configuration ensleeving the associated void, wherein each gate sleeve provides a gate button hole dimensioned to slidable receive the associated locking button, and wherein gate threading is provided along an inner periphery of each gate sleeve, wherein the gate threading is adapted to engage the associated link threading; and
a pin disposed within the through bore of each link for making the two links rotatable relative to each other in opposing direction.

8. The device of claim 7, wherein each open loop link defines an oval shape.
